(19) United States
(12) Patent Application Publication
(10) Pub. No.: US 2013/0128208 A1
(43) Pub. Date: May 23, 2013

(54) Pixel Electrode and LCD Panel

(71) Applicants: Xiaohui Yao, Shenzhen (CN); Je-hao Hsu, Shenzhen (CN); Jingfeng Xue, Shenzhen (CN); Chengcai Dong, Shenzhen (CN)

(72) Inventors: Xiaohui Yao, Shenzhen (CN); Je-hao Hsu, Shenzhen (CN); Jingfeng Xue, Shenzhen (CN); Chengcai Dong, Shenzhen (CN)

(21) Appl. No.: 13/378,504

(22) PCT Filed: Dec. 2, 2011
(86) PCT No.: PCT/CN2011/083335

§ 371 Date: Dec. 15, 2011

(30) Foreign Application Priority Data
Nov. 21, 2011 (CN) 201110371616.6

(51) Int. Cl. G02F 1/1343

(52) U.S. Cl. 349/142; 349/139

(57) ABSTRACT

The present invention discloses a pixel electrode and an LCD panel. The pixel electrode is provided with at least one gap which is inclined with respect to the edges of the pixel electrode, wherein both ends of each gap extend to the edges of the pixel electrode; both sides of each gap is provided with a plurality of equal slits with a constant depth; both sides of the two end zones of each gap have a plurality of edge slits of which the bottom sections are extended to the edges of the pixel electrode; the end zones of each gap are also provided with a plurality of gradual slits which are gradually decreased in depth from the outer to the inner of the pixel electrode; and the depth of each gradual slit is greater than or equal to that of each equal slit. The present invention mitigates the anomalous electric fields among the slits and that of at the slit ends on the extension structures of the common electrodes by changing the depth of the edge slits of the pixel electrode; at the same time, the gradual slits are formed on one side of each edge slit, so that the electric fields at the edges are gradually changed and transited to the electric fields within the pixels. Thus, the anomalous disclination of the liquid crystal molecules in this region can be avoided, the hidden veins herein can be reduced, and the penetration rate of pixel can be enhanced.

### TECHNICAL FIELD

The present invention relates to the field of liquid crystal displays, and more particularly to a pixel electrode and a liquid crystal display (LCD) panel.

### BACKGROUND

LCD devices are widely applied to human life and work, wherein the display effect of the LCD devices is affected by an LCD panel therein, such as visual angle, brightness and color, etc.

As shown in FIG. 1, common electrodes 200 within a pixel region of an existing LCD panel overlaps with pixel electrodes 100, wherein, as shown in FIG. 3, the pixel electrodes 100 are provided with two symmetrical gaps 10 which are inclined with respect to the edges of the pixel electrodes 100; both ends of each gap 10 are extended to the edges of the pixel electrodes 100 and both sides of each gap 10 are provided with a plurality of equal slits 11 with a constant depth. And as shown in FIG. 1, the junctions of the gaps 10 at the edges are the edge junctions of the common electrodes 200 and the pixel electrodes 100, namely, a first junction 1, a second junction 2, a third junction 3, and a fourth junction 4 in FIG. 1, of which structures differ from the inner structure of the pixel, causing the electric field distribution at the pixel edges to differ from that of in the pixel inner to produce the fringe field effect on the LC (liquid crystal). Thus, the liquid crystal molecules of these junctions have the anomalous disclination, and the pixel thereon has lower penetration rate. To resolve the problem, the slits are often to be added on the side edges of the common electrodes 200. As shown in FIG. 2, taking the second junction 2 for example, an extension structure 210 is arranged on the junction of the common electrodes 200 and the pixel electrodes 100, and a wing-shaped slit pattern is formed on the extension structure 210. The slits are formed at the edges by using the extension structure 210 to mitigate the influence on the liquid crystal molecules of the second junction 2 by the fringe field effect. But, because the electric fields among the slits and that of at the slit edges still differ from the inner electric fields of the pixel, the anomalous disclination of the liquid crystal molecules will still occur. As shown in FIG. 1, the anomalous disclination of the liquid crystal molecules is still existed in the first junction 1, the second junction 2, the third junction 3, and the fourth junction 4. Thus, the penetration rate of the four junctions is reduced as well as that of the whole pixel.

### SUMMARY

One aim of the present invention is to provide a pixel electrode and an LCD panel which are available to improve the penetration rate of the LCD panel.

The aim of the present invention is achieved by the following technical schemes. A pixel electrode is provided with at least one gap which is inclined with respect to the edges of the pixel electrode, wherein both ends of each gap are extended to the edges of the pixel electrode; both sides of each gap are provided with a plurality of equal slits with a constant depth; both sides of the two end zones of each gap have a plurality of edge slits of which the bottom sections are extended to the edges of the pixel electrode; the end zones of each gap are also provided with a plurality of gradual slits which are gradually decreased in depth from the outer to the inner of the pixel electrode; and the depth of each gradual slit is greater than or equal to that of each equal slit.

Preferably, the bottom of the edge slits and the edges of the pixel electrode are parallel to each other and in one straight line. Thus, the edge slits can be disclinated on the edges of the pixel electrode at a constant depth difference to avoid producing the anomalous electric fields.

Preferably, the depth of the gradual slits is gradually decreased in the direction from the outer to the inner of the pixel electrode, so that the gradual slits can gradually transit the anomalous electric fields at the edges to the inner of the pixel. Thus, the anomalous disclination of the liquid crystal molecules is avoided.

Preferably, the gradual slits are disclinated in the mode that the depth is gradually decreased at a constant depth difference, so that the electric fields at the edges can be transited to the inner electric fields in a relatively mitigatory manner. Thus, the hidden veins caused by the anomalous disclination of the liquid crystal molecules are avoided.

Preferably, the depth difference is S/N, wherein, N refers to the number of the gradual slits; S refers to the distance from the opening of the slits on the common electrodes to the bottom of the equal slits on the pixel electrode within a pixel region in the LCD panel. The constant depth difference and the number of the gradual slits are determined as required to achieve the best optimization method.

Preferably, N=3, it is a better number for the gradual slits. Thus, the electric fields can obtain a better transition without increasing new anomalous electric fields.

Preferably, the gradual slits are disclinated in the mode that the depth is gradually decreased at an incremental depth difference, so that a more mitigatory transition mode can be obtained. It is better than the mode of constant depth difference.

Preferably, the number of the gradual slits is 4, and it is a better number for the gradual slits. Thus, the electric fields can obtain a better transition without increasing the new anomalous electric fields.

Preferably, the pixel electrode comprises two gaps disclinated symmetrically. This is a better disclination mode for the gaps. Thus, the tipping of liquid crystal molecules with a plurality of directions can be obtained to enhance the scope of the visual angle.

Preferably, on the pixel electrode, the gaps are disclinated in “ [symbol] ” shape or “ [symbol] ” shape. This is a better disclination shape. Thus the tipping of liquid crystal with a plurality of directions can be formed to improve the scope of the visual angle.

An LCD panel comprises the common electrodes and a plurality of pixel electrodes arranged oppositely of any one of the above mentioned.

Preferably, the common electrodes are correspondingly provided with the slits which are correspondingly staggered with the pixel electrodes; the edge junctions of the common electrodes and the pixel electrodes are provided with extension structures for arranging slits at the edges; the edge slits of the pixel electrode correspond to the extension structures of the common electrodes; and the distance, from the bottom of the gradual slits of the pixel electrode to the corresponding slits of the common electrodes, is gradually reduced. The edge slits correspond to the slits on the extension structures to eliminate the anomalous electric fields among the slits and that of at the slit ends on extension structures. At the same time, the distance, from the gradual slits to the slits among the corresponding common electrodes, is gradually reduced. This can serve as a transition to make the electric fields at the edges slowly changed to correspond to the inner electric fields. Thus, the anomalous turnover of the liquid crystal is avoided and the penetration rate of pixel can be improved.

Preferably, the edge slits have a deepest boundary point slit, and the depth of the boundary point slit is greater than that of each equal slit. Only the depth of each edge slit is greater than that of each equal slit, the slits on the extension structures can be eliminated effectively.

Preferably, the depth of the boundary point slit is greater than S+D, wherein, S refers to the distance from the opening of the slits on the common electrodes to the bottom of the equal slits on the pixel electrode within a pixel region in the LCD panel; and D refers to the depth of the equal slits. In this way, the boundary point slit and other slits can extend to the edges of the pixel electrode to correspond to the slits on the transition segments of the common electrodes. Thus, the anomalous electric fields among the slits and that of at the slit edges herein can be effectively mitigated, and the reason is that the bottom of the edge slits is parallel to each other and in one straight line.

An LCD panel comprises common electrodes and a plurality of pixel electrodes arranged oppositely, wherein the common electrodes are correspondingly provided with the slits which are correspondingly staggered with the pixel electrodes; a saw tooth is formed between the adjacent common electrodes; edge junctions of the common electrodes and the pixel electrodes are provided with the extension structures for arranging slits at the edges; the pixel electrodes are provided with at least one gap which is inclined with respect to the edges of the pixel electrodes, and both ends of each gap extend to the edges of the pixel electrodes; both sides of the two end zones of each gap have a plurality of edge slits of which the bottom sections are extended to the edges of the pixel electrodes, and the edge slits of the pixel electrodes correspond to the extension structures of the common electrodes; and the extension structures and the saw tooth thereby extend to the equal slits of the pixel electrodes corresponding to the saw tooth. Thus, the distance from the saw tooth to the slits among the pixel electrodes is gradually reduced.

The present invention, by changing the depth of the slits at the edges of the pixel electrodes as well as that of on the both sides of the end of each gap, makes a part of slits in this region extend to the edges of the pixel electrodes to form the edge slits, so as to correspond to the slits on the extension structures of the common electrodes of the LCD panel and mitigate the anomalous electric fields among the slits and that of at the slit ends herein; at the same time, the gradual slits are formed on one side of each edge slit, so that the electric fields at the edges are gradually changed and transited to the electric fields within the pixels. Thus, the anomalous disclination of the liquid crystal molecules in this region can be avoided, the hidden veins herein can be reduced, and the penetration rate of pixel can be enhanced.

### BRIEF DESCRIPTION OF FIGURES

FIG. 1 is a diagram of an overlap structure of the common electrodes and the pixel electrodes of an existing LCD panel;

FIG. 2 is a structural enlarged view of the second junction 2 in FIG. 1;

FIG. 3 is a structural diagram of the pixel electrodes in an existing LCD panel;

FIG. 4 is a structural enlarged view of the pixel electrodes corresponding to the second junction 2 in FIG. 1;

FIG. 5 is a diagram of an overlap structure of the common electrodes and the pixel electrodes of an LCD panel in a first example of the present invention;

FIG. 6 is a structural enlarged view of the second junction 2 in FIG. 5;

FIG. 7 is a structural diagram of the pixel electrodes in the first example of the present invention;

FIG. 8 is a structural enlarged view of the second junction 2 in FIG. 7;

FIG. 9 is a diagram of an overlap structure of the common electrodes and the pixel electrodes of ang LCD panel in a second example of the present invention;

FIG. 10 is a structural enlarged view of the second junction 2 in FIG. 9;

FIG. 11 is a structural diagram of the pixel electrodes in the second example of the present invention;

FIG. 12 is a structural enlarged view of the second junction 2 in FIG. 11;

FIG. 13 is an analog simulation drawing of the penetration rate of an existing LCD panel;

FIG. 14 is an analog simulation drawing of the penetration rate in the first example;

FIG. 15 is an analog simulation drawing of the penetration rate in the second example;

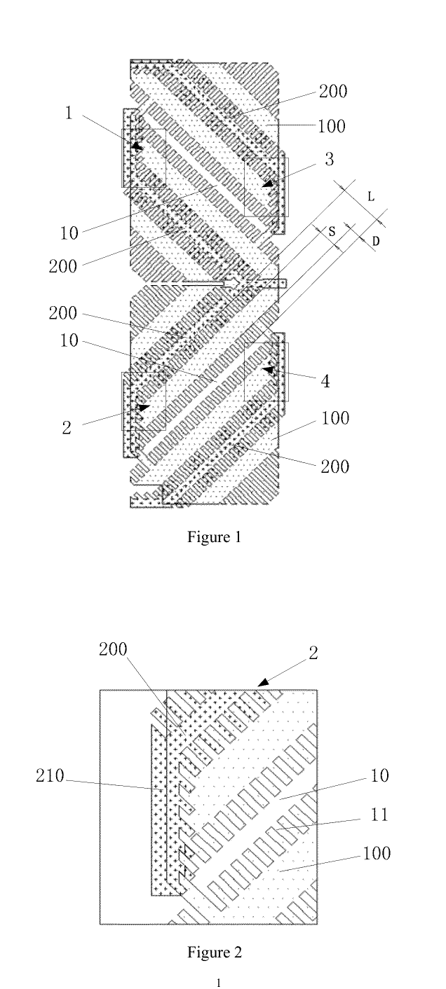

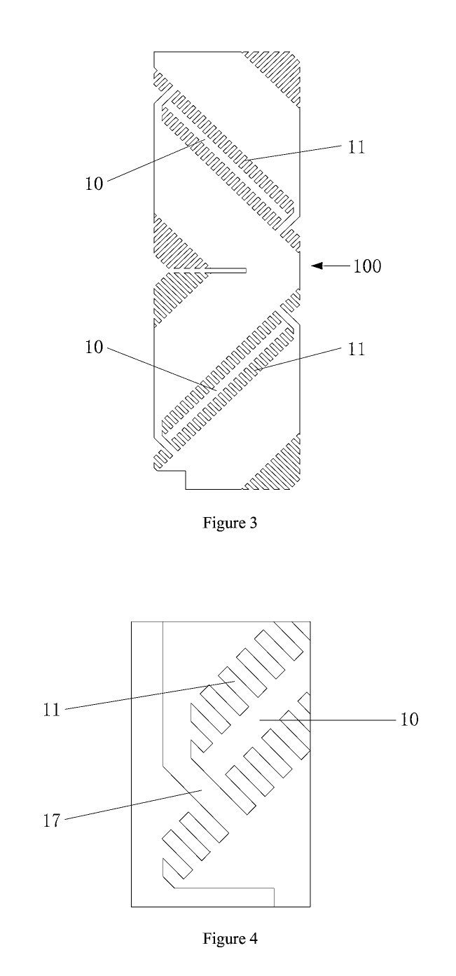

Wherein: 1. first junction; 2. second junction; 3. third junction; 4. fourth junction; 10. gap; 11. equal slit; 12. gradual slit; 13. edge slit; 14. boundary point slit; 17. connecting part; 100. pixel electrode; 200. common electrode; 210. extension structure.

### DETAILED DESCRIPTION

The present invention will further be described in detail in accordance with the figures and the preferred examples.

Pixel electrodes of the present invention comprise at least one gap which is inclined with respect to the edges of the pixel electrodes. Both ends of each gap extend to the edges of the pixel electrodes; both sides of each gap are provided with a plurality of equal slits with a constant depth; both sides of the two end zones of each gap have a plurality of edge slits of which the bottom sections are extended to the edges of the pixel electrodes; the bottom of the edge slits are parallel to the edges of the pixel electrodes and in one straight line; and the end zones of each gap are also provided with a plurality of gradual slits which are gradually decreased in depth from the outer to the inner of the pixel electrodes, and the depth of each gradual slit is greater than or equal to that of each equal slit. In an LCD panel, the common electrodes is also provided with the slits which correspond to the equal slits, the edge slits as well as the gradual slits on the pixel electrodes and stagger with each other.

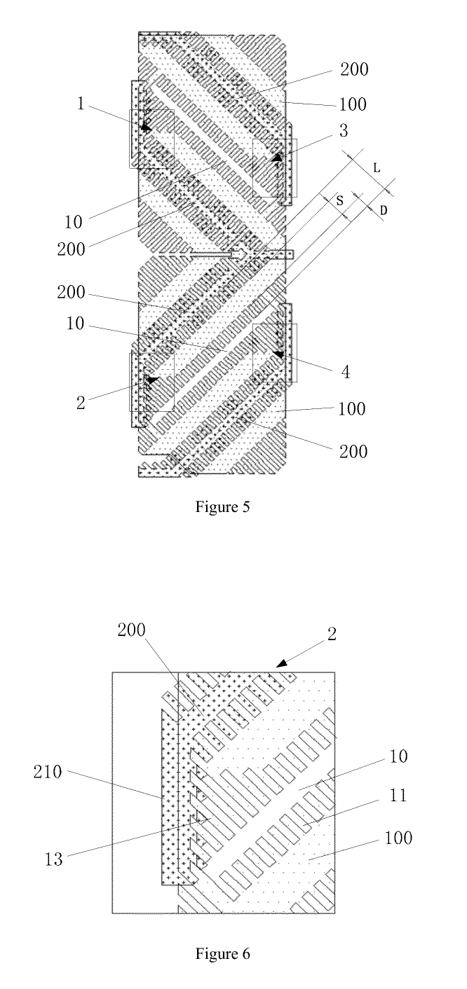

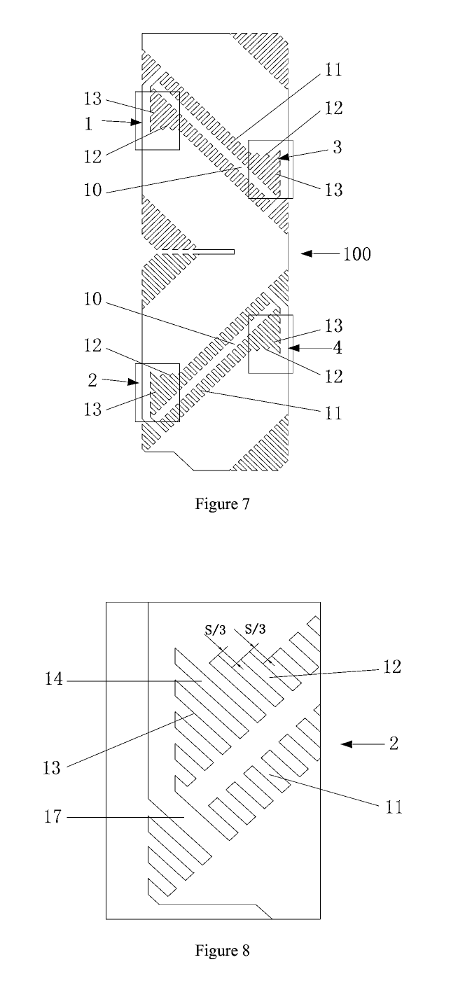

The preferred examples of the present invention are as shown in FIG. 5 to FIG. 8. Firstly, in FIG. 7, two symmetrical gaps 10 are arranged on the pixel electrodes 100; the gaps 10 are extended to the edges of the pixel electrodes 100; a plurality of equal slits 11 with a constant depth are respectively arranged on the both sides of the gaps 10; both sides at the ends of the gaps 10 are provided with a plurality of edge slits 13 of which the bottom sections are parallel to the pixel electrodes 100 and in one straight line; and a plurality of gradual slits 12 are arranged (from the outer to the inner of the pixel electrodes 100) on the inside of the edge slits 13. As shown in FIG. 8, taking the junction 2 which is the end section of the gaps 10 for example, three gradual slits 12 are arranged on the junction 2 in the disclination mode that the depth difference is gradually decreased at S/3, wherein, the depth of the third gradual slit 13 (i.e. the gradual silt with the minimum depth) is equal to that of each equal slit 11; and as shown in FIG. 5, S refers to the distance from the bottom section of the equal slits 11 of the pixel electrodes 100 to the opening of the slits of common electrodes 200 corresponding to the common electrodes on a plane.

In this example, as shown in FIG. 6, the number of the edge slits 13 corresponds to that of the slits on the extension structures of the common electrodes 200, so that the fringe field effects as well as the anomalous electric fields among the slits and that of at the slit ends on the extension structures 210 can be mitigated. The edge slits 13 comprise a deepest boundary point slit 14 of which the depth is greater than S+D and less than L, wherein, as shown in FIG. 5, L refers to the distance from the opening of the equal slits of the pixel electrodes 100 to the bottom of the slits of the corresponding common electrodes 200 on a plane, and D refers to the depth of each equal slit on the pixel electrodes. The outer area of the boundary point slit (from the inner to the outer of the pixel electrodes) is the disclination area of the edge slits 13, and the edge slits start at a connecting part 17, wherein, the connecting part 17 is located on the tip of the gaps and for linking the pixel electrode parts separated by the gaps. The inner area of the boundary point slit is the disclination area of the gradual slits.

In the example, the number of the gradual slits can be determined as required, that is, the depth difference can be changed into S/N, wherein, N refers to the number of the gradual slits.

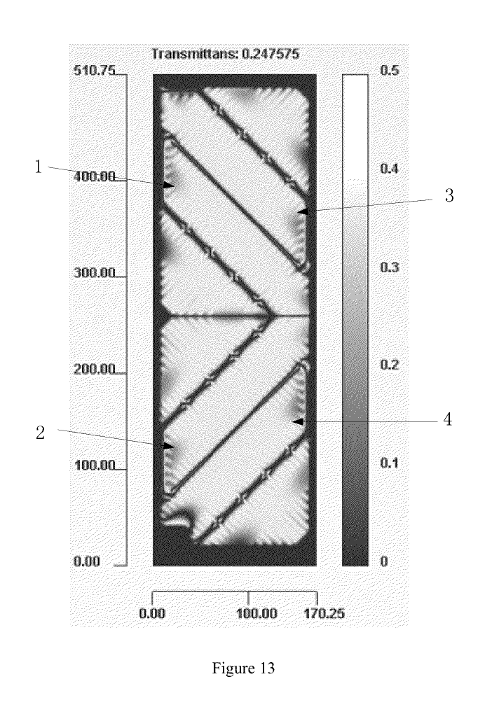

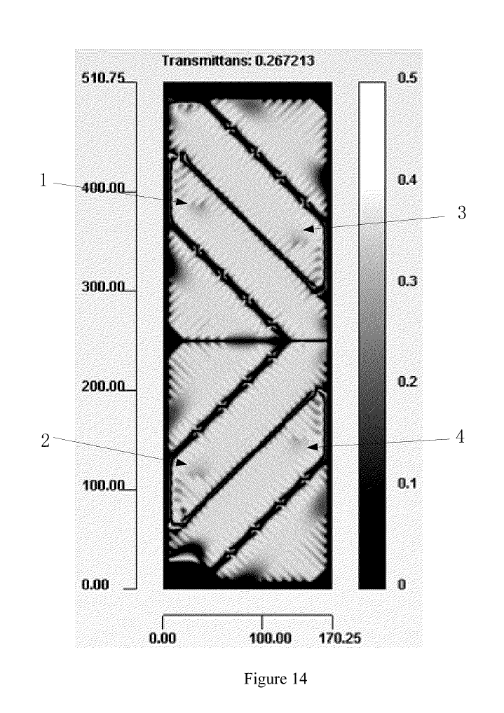

In the example, the pixel electrodes 100 are structurally optimized at the first junction 1, the second junction 2, the third junction 3, and the fourth junction 4. Taking the second junction 2 for example, the edge slits 13 are extended to the edges of the pixel electrodes 100 to mitigate the influence by the fringe field effect and the anomalous electric fields among the slits and that of at the slit ends on the extension structures 210 of the common electrodes 200; besides, a more mitigatory gradual area of the electric fields is formed through the gradual slits 12 to reduce the influence on the liquid crystal by the electric fields perpendicular to the slits. Identically, so do other junctions (the first junction, the third junction and the fourth junction). By mitigating the fringe field effect and forming the gradual electric fields, the anomalous disclination of the liquid crystal molecules at these junctions can be reduced to improve the penetration rate of pixel. For example, FIG. 14 is an analog simulation situation of the penetration rate of pixel after using the pixel electrodes of the example, compared with the analog simulation situation of the penetration rate of the existing LCD panel as shown in FIG. 13, and the penetration rate is increased by 7.93% after optimizing and improving.

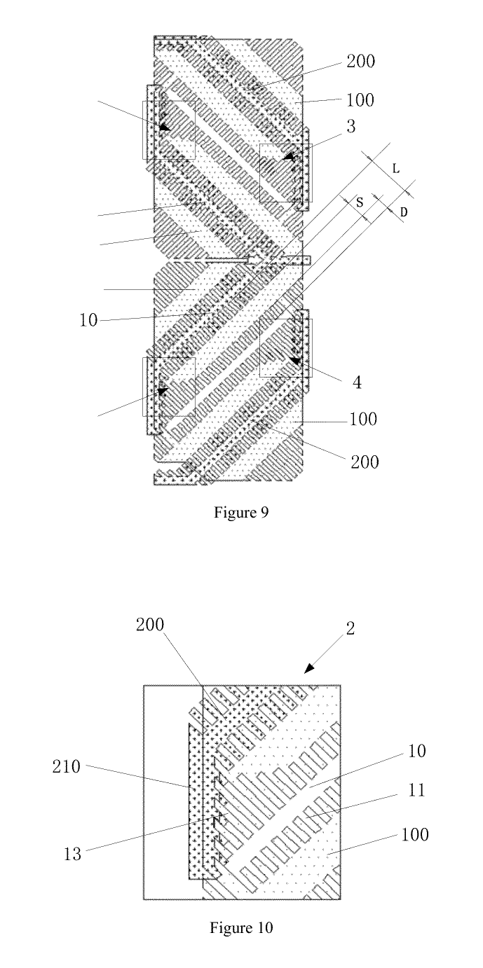

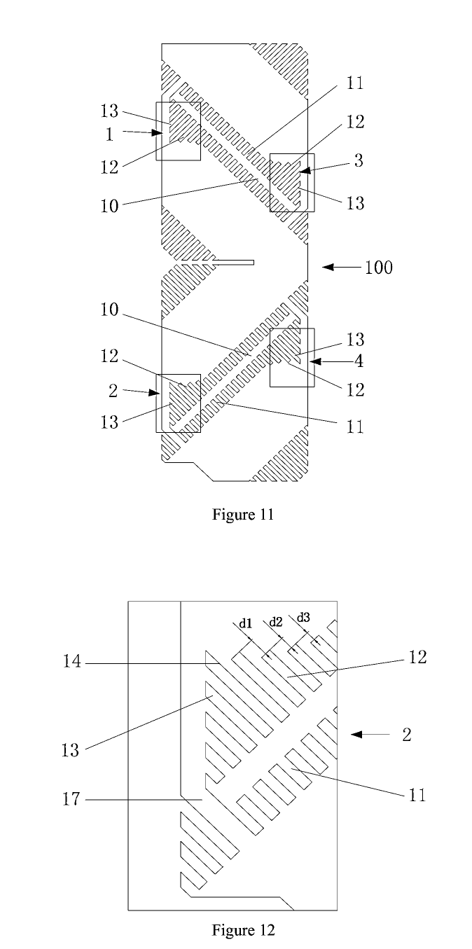

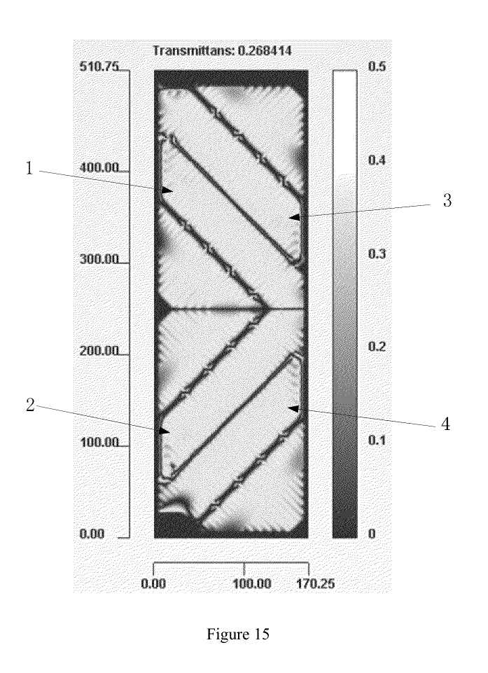

A second example of the present invention is as shown in FIG. 9 to FIG. 12, unlike the first example, the gradual slits at the edge of the gaps 10 are disclinated degressively in depth in the mode that the depth difference is gradually decreased. As shown in FIG. 9, still taking the second junction 2 which is the tip of the gaps 10 for example, a plurality of gradual slits 12 are disclinated on the inside of the boundary point slits 14. In the example, the number of the gradual slits 12 preferably is 4, wherein: a first gradual slit is in the nearest place with the boundary point slit 14 and depth of the first gradual slit is less than that of the boundary point slit 14 and less than S+D; the depth difference between a second gradual slit and the first gradual slit is d1; the depth difference between the second gradual slit and a third gradual slit is d2; and the depth difference between the third gradual slit and a fourth gradual slit is d3. Wherein, d1>d2>d3, and thus the disclination that the depth difference is gradually decreased from the outer to the inner of the pixel structure is formed. Under this disclination, the gradual slits form a more mitigatory disclination than that in the first example in which the depth difference is a constant value. Thus, on the LCD panel, the gradual changing of the electric field in the area is more mitigatory, so that the influence on the liquid crystal by the electric fields perpendicular to the slit direction can be further reduced. The analog simulation result of the penetration rate of pixel in the example is as shown in FIG. 15, compared with the existing technical analog simulation result (i.e. FIG. 13), on the basis of the improvement in the example, the penetration rate of pixel is increased by 8.42%. And compared with the result of the first example as shown in FIG. 14, on the basis of the second example, the penetration rate of pixel is increased by 0.45%.

In two examples of the present invention, the pixel electrodes comprise two symmetrical gaps which are disclinated in “ [symbol] ” shape or “ [symbol] ” shape within the pixel electrodes. Thus, the tripping of liquid crystal molecules is formed in different directions to enhance the scope of the visual angle. Of course, the disclination mode of the gaps is not limited to this mode.

Of course, in addition to arranging the slits that can correspondingly be extended to the extension structures to mitigate the anomalous electric fields among the slits or that of at the slit ends of the extension structures on the pixel electrodes, the common electrodes can be designed like this mode as well. In the LCD panel, the common electrodes are provided with the slits of common electrodes which correspond to all slits on the pixel electrodes and stagger with each other to form a saw tooth pattern. Wherein, the saw tooth is located between two adjacent slits, and the saw tooth on the extension structures can extend to the directions of the corresponding slits on the pixel electrodes; at the same time, the saw tooth near the common electrode of the extension structure can be designed according to the design of the equal slits of the pixel electrodes corresponding to the saw tooth. Under this arrangement, the anomalous electric fields among the slits and that of at the slit ends on the extension structures can be eliminated and the electric fields herein also can be slowly changed and transited to the inner electric field of pixel. However, for the above-mentioned example, the mode has larger changes in technology, and relatively, the above-mentioned example has easier implementation mode and lower production cost.

The present invention is described in detail in accordance with the above contents with the specific preferred examples. However, this invention is not limited to the specific examples. For the ordinary technical personnel of the technical field of the present invention, on the premise of keeping the conception of the present invention, the technical personnel can also make simple deductions or replacements, and all of which should be considered to belong to the protection scope of the present invention.

1. A pixel electrode, comprising: at least one gap which is inclined with respect to the edges of the pixel electrode; both ends of each gap are extended to the edges of said pixel electrode; both sides of each gap are provided with a plurality of equal slits with a constant depth; both sides of the two end zones of each gap have a plurality of edge slits of which the bottom sections are extended to the edges of said pixel electrode; and the end zones of each gap are also provided with a plurality of gradual slits, and the depth of each gradual slit is greater than or equal to that of each equal slit.

2. The pixel electrode of claim 1, wherein the bottom of said edge slits is parallel to the edges of said pixel electrode and in one straight line.

3. The pixel electrode of claim 1, wherein the depth of each gradual slit is gradually decreased in the direction from the outer to the inner of the pixel electrode.

4. The pixel electrode of claim 3, wherein said gradual slits are disclinated in the mode that the depth is decreased successively at a constant depth difference.

5. The pixel electrode of claim 4, wherein said depth difference is S/N, said N refers to the number of the gradual slits, said S refers to the distance from the opening of the slits of the common electrodes to the bottom of the equal slits of the pixel electrode within a pixel region in the LCD panel.

6. The pixel electrode of claim 5, wherein said N=3.

7. The pixel electrode of claim 3, wherein said gradual slits are disclinated in the mode that the depth is decreased successively at an incremental depth difference.

8. The pixel electrode of claim 7, wherein the number of said gradual slits is 4.

9. The pixel electrode of claim 1, wherein said pixel electrode comprises two gaps disclinated symmetrically.

10. The pixel electrode of claim 9, wherein said gaps are disclinated in “ [symbol] ” shape or “ [symbol] ” shape on the pixel electrode.

11. An LCD panel, comprising: common electrodes and a plurality of pixel electrodes arranged oppositely of claim 1; said pixel electrode is provided with at least one gap which is inclined with respect to the edges of the pixel electrode; both ends of each gap are extended to the edges of said pixel electrode; both sides of each gap are provided with a plurality of equal slits with a constant depth; both sides of the two end zones of each gap have a plurality of edge slits of which the bottom sections are extended to the edges of said pixel electrode; and the end zones of each gap are also provided with a plurality of gradual slits, and the depth of each gradual slit is greater than or equal to that of each equal slit.

12. The LCD panel of claim 11, wherein the bottom section of said edge slits is parallel to the edges of said pixel electrode and in one straight line.

13. The LCD panel of claim 11, wherein the depth of each gradual slit is gradually decreased in the direction from the outer to the inner of the pixel electrode.

14. The LCD panel of claim 13, wherein said gradual slits are disclinated in the mode that the depth is decreased successively at a constant depth difference.

15. The LCD panel of claim 14, wherein said depth difference is S/N, said N refers to the number of the gradual slits, said S refers to the distance from the opening of the slits of the common electrodes to the bottom section of the equal slits of the pixel electrode within a pixel region in the LCD panel.

16. The LCD panel of claim 15, wherein said N=3.

17. The LCD panel of claim 13, wherein said gradual slits are disclinated in the mode that the depth is decreased successively at an incremental depth difference.

18. The LCD panel of claim 17, wherein the number of said gradual slits is 4.

19. The LCD panel of claim 11, wherein said pixel electrode comprises two gaps disclinated symmetrically.

20. The LCD panel of claim 19, wherein said gaps are disclinated in “ [symbol] ” shape or “ [symbol] ” shape on the pixel electrode.

21. The LCD panel of claim 11, wherein said common electrodes is correspondingly provided with the slits of common electrodes which are correspondingly staggered with said pixel electrode; the edge junctions of said common electrodes and said pixel electrode are provided with the extension structures for arranging slits at the edges; the edge slits of said pixel electrode correspond to the extension structures of said common electrodes; and the distance from the bottom section of the gradual slits on said pixel electrode to the corresponding slits of the common electrodes is gradually reduced.

22. The LCD panel of claim 12, wherein said edge slits have a deepest boundary point slit, and the depth of said boundary point slit is greater than that of each equal slit.

23. The LCD panel of claim 13, wherein the depth of said boundary point slit is greater than S+D; said S refers to the distance from the opening of the slits on the common electrodes to the bottom of the equal slits on the pixel electrode within a pixel region in the LCD panel; and said D refers to the depth of each equal slit.

24. An LCD panel, comprising: common electrodes and a plurality of pixel electrodes arranged oppositely, said common electrodes are correspondingly provided with the slits of common electrodes which are correspondingly staggered with said pixel electrode; a saw tooth is formed between the adjacent slits of the common electrodes; the edge junctions of said common electrodes and said pixel electrode are provided with the extension structures for arranging slits at the edges; said pixel electrode is provided with at least one gap which is inclined with respect to the edges of the pixel electrode, both ends of each gap extend to the edges of said pixel electrode; both sides of the two end zones of each gap have a plurality of edge slits of which the bottom sections are extended to the edges of said pixel electrode; the edge slits of said pixel electrode correspond to the extension structures of said common electrodes; and said extension structures and the saw tooth thereby are extended to the equal slit of said pixel electrode corresponding to the saw tooth; thus, the distance from said saw tooth to the slits among said pixel electrode is gradually reduced.
